(19) United States
(12) Patent Application Publication
(10) Pub. No.: US 2025/0045523 A1
(43) Pub. Date: Feb. 6, 2025

(54) Execution Methods of a Machine Learning Model

(71) Applicant: MEDIATEK INC., Hsin-Chu (TW)

(72) Inventors: Min-Yuan Tseng, Hsinchu City (TW); Jung-Hau FOO, Singapore (SG)

(73) Assignee: MEDIATEK INC., Hsin-Chu (TW)

(21) Appl. No.: 18/749,630

(22) Filed: Jun. 21, 2024

Related U.S. Application Data
(60) Provisional application No. 63/517,122, filed on Aug. 2, 2023.

(51) Int. Cl. G06F 40/284

(52) U.S. Cl. CPC G06F 40/284

(57) ABSTRACT

An execution method of a machine learning model, comprising: generating output and a begin of sentence (BoS) cache of a BoS token using the machine learning model before or after performing model quantization on the machine learning model to generate a quantized model; and executing inference based on the quantized model, and during the inference, input the next token following the BoS token as a first input token and the BoS cache into the quantized model to generate output and cache of the next token, wherein the next token is based on the output of the Bos token or based on an input content.

### CROSS REFERENCE TO RELATED APPLICATIONS

This application claims the benefit of U.S. Provisional Application No. 63/517,122, filed on Aug. 2, 2023. The content of the application is incorporated herein by reference.

### BACKGROUND

An autoregressive language model is a type of Machine Learning model that uses autoregressive techniques to predict the next word in a sequence of words based on the words that have come before the next word. The autoregressive language model can be used for tasks such as natural language processing and machine translation.

Model quantization is a technique to reduce the computational and memory costs of running inference by representing the weights and activations with low-precision data types like 8-bit integer (int8) instead of the usual 32-bit floating point (float32). Reducing the number of bits means the resulting model requires less memory storage, consumes less energy, and operations like matrix multiplication can be performed much faster with integer arithmetic. Model quantization also allows machine learning models to run on embedded devices, which sometimes only support integer data types.

Autoregressive Language Models use the generated token as the next input token of the model and produce cache or memory of the current token for the next token. However, Outliers occur when begin of sentence (BoS) token (since it produces large activation values) is input into a quantized autoregressive Language Model. Therefore, a scheme to reduce the outlier caused by BoS is desired.

### SUMMARY

An embodiment provides an execution method of a machine learning model, comprising: generating output and a begin of sentence (BoS) cache of a BoS token using the machine learning model before or after performing model quantization on the machine learning model to generate a quantized model; and executing inference based on the quantized model, and during the inference, input the next token following the BoS token as a first input token and the BoS cache into the quantized model to generate output and cache of the next token, wherein the next token is based on the output of the Bos token or based on an input content.

Another embodiment provides an execution method of a machine learning model, comprising: generating output and a fixed sequence cache of a fixed sequence of tokens using the machine learning model before or after performing model quantization on the machine learning model to generate a quantized model; and executing inference based on the quantized model, during the inference, input the next token following the fixed sequence of tokens and the fixed sequence cache into the quantized model to generate output and Cache of the next token, wherein the next token is based on the output of the fixed sequence of tokens or based on an input content.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a computer system according to an embodiment of the present disclosure.

FIG. 2 is the flowchart of an execution method of a machine learning model according to an embodiment of the present disclosure.

FIG. 3 is the flowchart of another execution method of a machine learning model according to an embodiment of the present disclosure.

### DETAILED DESCRIPTION

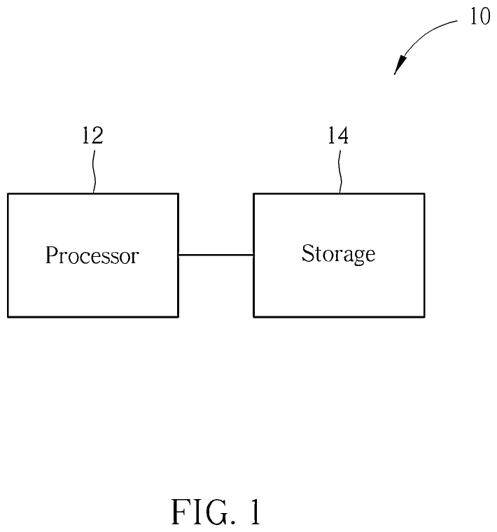

FIG. 1 is a block diagram of a computer system 10 according to an embodiment of the present disclosure. The computer system 10 comprises a processor 12 and a storage (such as a cache) 14 coupled to the processor 12.

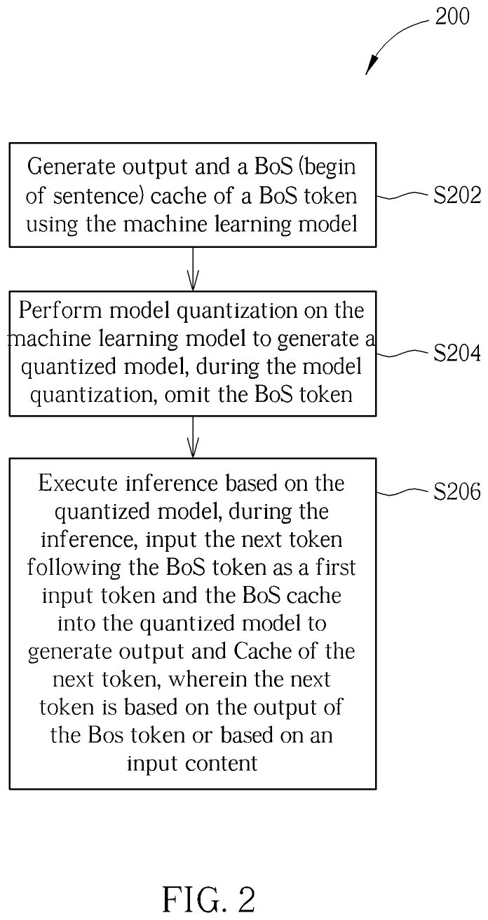

FIG. 2 is the flowchart of an execution method 200 of a machine learning model according to an embodiment of the present disclosure. The execution method 200 may be performed in the processor 12. The storage 14 may be accessed in Steps S202 to S206. The execution method 200 may include the following steps:
Step S202: Generate output and a BoS (begin of sentence) cache of a BoS token using the machine learning model;
Step S204: Perform model quantization on the machine learning model to generate a quantized model, during the model quantization, omit the BoS token; and
Step S206: Execute inference based on the quantized model, during the inference, input the next token following the BoS token as a first input token and the BoS cache into the quantized model to generate output and Cache of the next token, wherein the next token is based on the output of the Bos token or based on an input content.

In step S202, the output and the BoS cache of the BoS token are generated using the machine learning model, and the machine learning model is an un-quantized model. In an embodiment, generate a predicted token based on the output of the BoS token. In another embodiment, the next token is a user-defined token which is based on an input content received by a user interface. For example, a user can input contents trough a user interface of a device which executes the un-quantized machine learning model and the quantized model. The predicted token or the user-defined token will be used as the next token of the quantized model. In an embodiment, the BoS cache is a subset of the activation values generated by the machine learning model when the input token is the BoS token, and the BoS cache is used as information to indicate the BoS token is at the beginning of all the input tokens. In an embodiment, the machine learning model can be a large language model (LLM), such as an autoregressive language model. In an embodiment, the BoS cache can be stored in a storage (such as the storage 14) first so as to be utilized during inference of the machine learning model. In step S204, model quantization is performed on the machine learning model to generate the quantized model. In this embodiment, the output and the BoS cache of a BoS token are generated by using the machine learning model before performing model quantization on the machine learning model (that is, before the quantized model is generated). In other embodiments, the output and the BoS cache of the BoS token are generated by using the machine learning model after performing model quantization on the machine learning model (that is, after the quantized model is generated). In an embodiment, the input tokens except the BoS token (or any input token used as training data) are classified into N groups based on activation ranges produced by these input tokens, where N is a positive integer. In the procedure of classification, the input tokens with similar activation ranges are grouped together. The model quantization is performed for each of the N groups to generate the quantized model with N types of parameters. Other tokens that cause outliers can be handled with N sets of activation quantization parameters, temporarily increasing the data range without sacrificing precision when data range is small.

In this disclosure, since the BoS token won't be used during inference stage, in step S206, during the inference, input the next token following the BoS token as a first input token and load the BoS cache to assist generating output of the next token, in this way, the outlier generated by the BoS token can be avoided, and the precomputed BoS cache maintains the accuracy of the machine learning model instead of the quantized model with less accuracy, which further enhances the quality of the quantized model. In an embodiment, in step S206, a type of parameters in the quantized model of the N types of parameters is selected based on the first input token to generate corresponding output. The output of the first input token and a new cache which indicates that the BoS token and the first token are at the beginning of all the input tokens are saved in the storage 14 to be utilized in inference of the machine learning model to predict other output of another input token (such as, a second input token). In an embodiment, during the inference, after generating the output of the first input token, input a second token after the first input token and the new cache to generate output of the second token. Similarly, the second token is based on the output of the first input token or defined by a user. In an embodiment, the second token is the output of the first input token. The operations to generate the output of other input tokens are similar to the second token, and are omitted for the sake of conciseness. In an embodiment, the inference ends when the output of an input token indicates all the input tokens have been input to the quantized model.

In an embodiment, the machine learning model is based on 32-bit floating point (that is, float data type) with high precision while the quantized model is based on 8-bit integer (that is, integer data type) with low precision. That is, the output and BoS cache of the BoS token are generated based on 32-bit floating point with high precision. During inference of the quantized model, input tokens except the BoS token, the BoS cache, and the generated cache of the input tokens are input into the quantized model to generate the outputs of the input tokens. Therefore, the use of the BoS cache in this disclosure not only avoid outlier but also enhance the quality of the quantized model.

In an embodiment, four input tokens each corresponds to a word in a sentence “Who are you?” can be input sequentially into the quantized model after a BoS token (e.g., labeled by <s>) is input into the un-quantized machine learning model. In an embodiment, at least one word in the sentence “who are you?” is input by a user. For example, a user can input at least one word of the sentence “who are you?” through a user interface of a device which executes the un-quantized machine learning model and the quantized model, the words of “who are you?” are then transferred into four tokens, and the four tokens will be input into the quantized model. In step S202, generate output (e.g., a token indicates the word “who”) and a BoS cache of the BoS token using the machine learning model. In an example, the output (e.g., a token indicates the word “who”) and the BoS cache of the BoS token are saved in the storage 14. In an example, the output and the BoS cache of the BoS token are represented by floating points, such as 32-bit floating points, thus retaining the accuracy of the original machine learning model. In Step S204, perform model quantization on the machine learning model to generate a quantized model. Further, in Step S206, execute inference based on the quantized model, during the inference, input the next token (e.g., a token indicates the word “who”, this token is represented by an integer, such as a 8-bit integer) following the BoS token as a first input token and the BoS cache into the quantized model to generate output (e.g., a token indicates the word “are”, this token is represented by an integer, such as a 8-bit integer) and Cache of the next token. In an embodiment, the first input token (that is, the next token) is based on the output of the Bos token if a user doesn't input the word “who”. In another embodiment, the first input token is based on an input “who” which is received by a user interface. When the first input token (e.g., a token indicates the word “who”) is input to the quantized model, the BoS cache of the BoS token is loaded from the storage 14 to generate output (e.g., a token indicates the word “are”) of the first input token, and the output (e.g., a token indicates the word “are”) and a cache of the first input token are saved in the storage 14. When a second input token (e.g., a token indicates the word “are”) is input to the quantized model, the cache of the first input token is loaded from the storage 14 to generate the output (e.g., a token indicates the word “you”) of the second input token, and the output (e.g., a token indicates the word “you”) and a cache of the second input token are saved in the storage 14. In an embodiment, the second input token is based on the output of the first input token if a user doesn't input the word “are”. In another embodiment, the second input token is based on an input “are” which is received by user interface. When a third input token (e.g., a token indicates the word “you”) is input to the quantized model, the cache of the second input token is loaded from the storage 14 to generate the output (e.g., a token indicates the word “?”) of the third input token, and the output (e.g., a token indicates the word “?”) and a cache of the third input token are saved in the storage 14. In an embodiment, the third input token is based on the output of the second input token if a user doesn't input the word “you”. In another embodiment, the third input token is based on an input “you” which is received by a user interface. When a fourth input token (e.g., a token indicates the word “?”) is input to the quantized model, the cache of the third input token is loaded from the storage 14 to generate the output (e.g., a token (such as, </s>) indicates all the input tokens have been input to the quantized model) of the fourth input token, and the process ends.

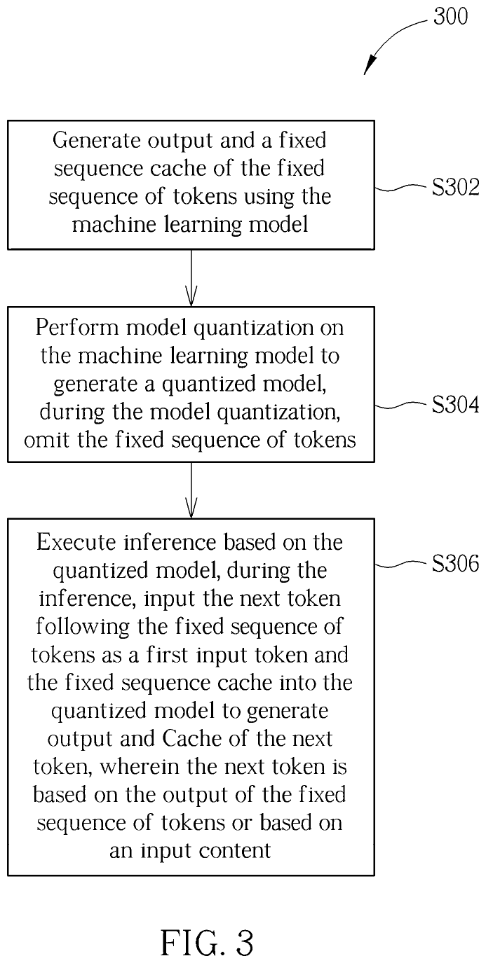

FIG. 3 is the flowchart of an execution method 300 using a fixed sequence cache for a machine learning model according to an embodiment of the present disclosure. All inputs of a fixed sequence of tokens are fixed no matter what the next token is, so it is deterministic and can be precomputed. A fixed sequence of tokens includes a BoS token and first M static tokens, where M is a positive integer. The execution method 300 may be performed in the processor 12. The storage 14 may be accessed in Steps S302 to S306. The execution method 300 may include the following steps:
Step S302: Generate output and a fixed sequence cache of the fixed sequence of tokens using the machine learning model;
Step S304: Perform model quantization on the machine learning model to generate a quantized model, during the model quantization, omit the fixed sequence of tokens; and
Step S306: Execute inference based on the quantized model, during the inference, input the next token following the fixed sequence of tokens as a first input token and the fixed sequence cache into the quantized model to generate output and Cache of the next token, wherein the next token is based on the output of the fixed sequence of tokens or based on an input content.

In step S302, the output and the fixed sequence cache of the fixed sequence of tokens are generated using a machine learning model, and the machine learning model is an un-quantized model. In an embodiment, generate a predicted token based on the output of the fixed sequence of tokens. In another embodiment, the next token is a user-defined token which is based on an input content received by a user interface. For example, a user can input contents trough a user interface of a device which executes the un-quantized machine learning model and the quantized model. The predicted token or the user-defined token will be used as the next token of the quantized model. In an embodiment, the fixed sequence cache is a subset of the activation values generated by the machine learning model when the input tokens are the fixed sequence of tokens, and the fixed sequence cache is used as information to indicate the fixed sequence tokens are at the beginning of all the input tokens. In an embodiment, the machine learning model can be a large language model (LLM), such as an autoregressive language model. In an embodiment, the fixed sequence cache can be stored in a storage (such as storage 14) so as to be utilized during inference of the machine learning model. In step S304, model quantization is performed on the machine learning model to generate the quantized model. In this embodiment, the output and the fixed sequence cache of the fixed sequence of tokens are generated by using the machine learning model which is un-quantized model before performing model quantization on the machine learning model (that is, before the quantized model is generated). In other embodiments, the output and the fixed sequence cache of the fixed sequence of tokens are generated by using the machine learning model after performing model quantization on the machine learning model (that is, after the quantized model is generated). In an embodiment, the input tokens except the fixed sequence tokens (or any input tokens used as training data) are classified into N groups based on activation ranges produced by these input tokens, where N is a positive integer. In the procedure of classification, the input tokens with similar activation ranges are grouped together. The model quantization is performed for each of the N groups to generate the quantized model with N types of parameters. Other tokens that cause outliers can be handled with N sets of activation quantization parameters, temporarily increasing the data range without sacrificing precision when data range is small.

In this disclosure, since the fixed sequence tokens won't be used during inference stage, in step S306, during the inference, input the next token following the fixed sequence tokens as a first input token and load the fixed sequence cache to assist generating outputs of the next token. In this way, the outlier generated by the fixed sequence tokens can be avoided, and the precomputed fixed sequence cache maintains the accuracy of the machine learning model instead of the quantized model with less accuracy, which further enhances the quality of the quantized model. In an embodiment, in step S306, a type of parameters in the quantized model of the N types of parameters is selected based on the first input token to generate corresponding outputs. The outputs of the first input token and a new cache which indicates that the fixed sequence tokens and the first token are at the beginning of all the input tokens are saved in the storage 14 to be utilized in inference of the machine learning model to predict other outputs of another input token (such as, a second input token). In an embodiment, during the inference, after generating the output of the first input token, input a second token after the first input token and the new cache of the first input token to generate output of the second token. Similarly, the second token is based on the output of the first input token or defined by a user. In an embodiment, the second token is the output of the first input token. The operations to generate the outputs of other input tokens are similar to the second token, are omitted for the sake of conciseness. In an embodiment, the inference ends when the output of an input token indicates all the input tokens have been input to the quantized model.

In an embodiment, the machine learning model is based on 32-bit floating point with high precision while the quantized model is based on 8-bit integer with low precision. That is, the output and fixed sequence cache of the fixed sequence of tokens are precomputed in 32-bit floating point with high precision. During inference of the quantized model, input tokens except the fixed sequence tokens, the fixed sequence cache, and the generated cache of the input tokens are input into the quantized model to generate the outputs of the input tokens. Therefore, the use of the fixed sequence cache in this disclosure not only avoid outlier but also enhance the quality of the quantized model.

In an embodiment, three input tokens each corresponds to a word of “are you?” can be input sequentially into the quantized model after a fixed sequence of tokens “<s>+Who” is input into the un-quantized machine learning model. In an embodiment, at least one word in the sentence “who are you?” is input by a user. For example, a user can input at least one word of the sentence “who are you?” through a user interface of a device which executes the un-quantized machine learning model and the quantized model, the words of “who are you?” are then transferred into four tokens, and the four tokens will be input into the un-quantized machine learning model or the quantized model. In step S302, generate output (e.g., a token indicates the word “are”) and a fixed sequence cache of the fixed sequence of tokens using the machine learning model. In an example, the output (e.g., a token indicates the word “are”) and the fixed sequence cache of the fixed sequence of tokens are saved in the storage 14. As an example, the output and the fixed sequence cache of the fixed sequence of tokens are represented by floating points, such as 32-bit floating points, thus retaining the accuracy of the original machine learning model. In Step S304, perform model quantization on the machine learning model to generate a quantized model. In Step S306, execute inference based on the quantized model, during the inference, input the next token (e.g., a token indicates the word “are”, this token is represented by an integer, such as a 8-bit integer) following the fixed token as a first input token and the fixed sequence cache into the quantized model to generate output (e.g., a token indicates the word “you”, this token is represented by an integer, such as a 8-bit integer) and Cache of the next token. In an embodiment, the first input token (that is, the next token) is based on the output of the fixed sequence of tokens if a user doesn't input the word “are”. In another embodiment, the first input token is based on an input “are” which is received by a user interface. When the first input token (e.g., a token indicates the word “are”) is input to the quantized model, the cache of the fixed sequence of tokens is loaded from the storage 14 to generate output (e.g., a token indicates the word “you”) of the first input token, and the output (e.g., a token indicates the word “you”) and a cache of the first input token are saved in the storage 14. When a second input token (e.g., a token indicates the word “you”) is input to the quantized model, the cache of the first input token is loaded from the storage 14 to generate the output (e.g., a token indicates the word “?”) of the second input token, and the output (e.g., a token indicates the word “?”) and a cache of the second input token are saved in the storage 14. In an embodiment, the second input token is based on the output of the first input token if a user doesn't input the word “you”. In another embodiment, the second input token is based on an input “you” which is received by a user interface. When a third input token (e.g., a token indicates the word “?”) is input to the quantized model, the cache of the second input token is loaded from the storage 14 to generate the output (e.g., a token (such as, </s>) indicates all the input tokens have been input to the quantized model) of the third input token, and the process ends.

As mentioned above, the proposed quantization method using the begin of sentence (BoS) cache or the fixed sequence cache for the machine learning model avoids the outlier and large activation range generated by BoS token in model quantization, and the BoS cache or the fixed sequence cache is utilized to store the precomputation of the BoS token with high precision. Therefore, the quantization method using the begin of sentence (BoS) cache for the machine learning model owns high accuracy and low consumption for inference.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An execution method of a machine learning model, comprising:
generating output and a begin of sentence (BoS) cache of a BoS token using the machine learning model before or after performing model quantization on the machine learning model to generate a quantized model; and
executing inference based on the quantized model, and during the inference, input the next token following the BoS token as a first input token and the BoS cache into the quantized model to generate output and cache of the next token, wherein the next token is based on the output of the Bos token or based on an input content.

2. The method of claim 1, wherein the BoS cache is used as information to indicate the BoS token is at the beginning of all the input tokens.

3. The method of claim 1, wherein the BoS token is omitted during the model quantization.

4. The method of claim 1, wherein performing the model quantization on the machine learning model to generate the quantized model comprises:
classifying the input tokens except the Bos token into N groups based on activation ranges produced by the input tokens, where N is a positive integer; and
performing model quantization for each of the N groups to generate the quantized model with N types of parameters.

5. The method of claim 4, wherein input tokens with similar activation ranges are grouped together.

6. The method of claim 4, further comprising:
during the inference, selecting a type of parameters of the N types of parameters based on an input token.

7. The method of claim 1, wherein generating the output and the BoS cache of the BoS token using the machine learning model comprises:
generating the output and the BoS cache of the BoS token by using the machine learning model which is based on float data type.

8. The method of claim 1, wherein generating the output and the BoS cache of the BoS token using the machine learning model comprises:
generating the output and the BoS cache of the BoS token by using the machine learning model which is an un-quantized model.

9. The method of claim 1, wherein performing the model quantization on the machine learning model to generate the quantized model comprises:
performing the model quantization on the machine learning model to generate the quantized model which is based on integer data type.

10. The method of claim 1, wherein the machine learning model is an autoregressive language model.

11. An execution method of a machine learning model, comprising:
generating output and a fixed sequence cache of a fixed sequence of tokens using the machine learning model before or after performing model quantization on the machine learning model to generate a quantized model; and
executing inference based on the quantized model, during the inference, input the next token following the fixed sequence of tokens and the fixed sequence cache into the quantized model to generate output and Cache of the next token, wherein the next token is based on the output of the fixed sequence of tokens or based on an input content.

12. The method of claim 11, wherein the fixed sequence cache is used as information to indicate the fixed sequence tokens are at the beginning of all the input tokens.

13. The method of claim 11, wherein the fixed sequence of tokens is omitted during the model quantization.

14. The method of claim 11, wherein performing the model quantization on the machine learning model to generate the quantized model comprises:
classifying the input tokens except the fixed sequence tokens into N groups based on activation ranges produced by the input tokens, where N is a positive integer; and
performing model quantization for each of the N groups to generate the quantized model with N types of parameters.

15. The method of claim 14, wherein input tokens with similar activation ranges are grouped together.

16. The method of claim 14, further comprising:
during the inference, selecting a type of parameters of the N types of parameters based on an input token.

17. The method of claim 11, wherein generating the output and the fixed sequence cache of fixed sequence of tokens comprises:
generating the output and the fixed sequence cache of fixed sequence of tokens by using the machine learning model which is based on float data type.

18. The method of claim 11, wherein generating the output and the fixed sequence cache of fixed sequence of tokens comprises:
generating the output and the fixed sequence cache of fixed sequence of tokens by using the machine learning model which is an un-quantized model.

19. The method of claim 11, wherein performing the model quantization on the machine learning model to generate the quantized model comprises:
performing the model quantization on the machine learning model to generate the quantized model which is based on integer data type.

20. The method of claim 11, wherein the fixed sequence of tokens comprises a begin of sentence (BoS) token and at least one other tokens.
